(19) United States
(12) Patent Application Publication
(10) Pub. No.: US 2023/0086054 A1
(43) Pub. Date: Mar. 23, 2023

(54) FRAME FOR LENS

(71) Applicant: Kenko Optics, Inc., Sakado-shi (JP)

(72) Inventor: Shuji MORIAI, Sakado-shi (JP)

(73) Assignee: Kenko Optics, Inc., Sakado-shi (JP)

(21) Appl. No.: 17/478,116

(22) Filed: Sep. 17, 2021

(51) Int. Cl. G02B 23/14; G02B 7/04; G02B 7/02

(52) U.S. Cl. CPC G02B 23/14; G02B 7/04; G02B 7/021

(57) ABSTRACT

In a frame for lens 20, a main body 21 is urged by the reaction force of an elastic member 24 toward the side on which an upper outer peripheral portion 22a is present, and support portions 23 that are formed on the upper outer peripheral portion 22a are brought into contact with an inner peripheral portion 9 of a stationary tube 5. Thus, the main body 21 is held by the stationary tube 5 without being tilted in the stationary tube 5.

### BACKGROUND OF THE INVENTION

### Field of the Invention

The present disclosure relates to a frame for lens.

### Description of the Related Art

In the related art, the magnification of a rifle scope is adjusted by moving a lens in a body tube in an optical axis direction. As a method of moving a lens in a body tube, for example, a configuration using a cam mechanism has been proposed (Japanese Unexamined Utility Model Registration Application Publication No. 6-69922).

The lens body tube described in Japanese Unexamined Utility Model Registration Application Publication No. 6-69922 includes has a zoom ring that has a cam groove formed in the inner periphery thereof, a stationary tube that has a guide groove formed in the outer periphery thereof and over which the zoom ring is fit such that the zoom ring is rotatable relative to the outer periphery of the stationary tube, and a lens holding tube that is disposed in the stationary tube while holding a lens on the inner periphery thereof and that is provided with a cam follower on the outer periphery thereof.

In the lens body tube, when the zoom ring is rotated about the optical axis, the cam follower is driven by being guided by the cam groove and the guide groove, and as the cam follower is driven, the lens holding tube moves in the optical axis direction. In other words, the lens holding tube reciprocates in the optical axis direction in response to a zoom operation.

In general, if there is a gap between the outer periphery of a lens holding tube and the inner periphery of a stationary tube, the central axis of the lens holding tube may sometimes become offset from or become inclined with respect to the optical axis when the lens holding tube moves. In order to prevent such inclination and offset, it is necessary to restrict movement of the lens holding tube in the stationary tube in directions other than the optical axis direction.

Accordingly, in the lens body tube, the above-mentioned inclination and offset are reduced by rigorously adjusting the tolerance of the inner diameter of the stationary tube and the tolerance of the outer diameter of the lens holding tube. More specifically, for example, the outer periphery of the lens holding tube is processed in such a manner that the lens holding tube has the outer diameter that corresponds to the inner diameter of the stationary tube. In this manner, by adjusting the size of the outer diameter of the lens holding tube in accordance with the inner diameters of stationary tubes having different sizes, the gap between the inner periphery of the stationary tube and the outer periphery of the lens holding tube is reduced, and movement of the lens holding tube in directions other than the optical axis direction can be restricted.

On the other hand, by reducing the gap between the inner periphery of the stationary tube and the outer periphery of the lens holding tube, the frictional resistance between the inner periphery of the stationary tube and the outer periphery of the lens holding tube becomes larger than that in the case in which the above-mentioned gap is not reduced. In particular, when the outer periphery of the lens holding tube is in contact with a corner portion of the cam groove or a corner portion of the guide groove, the corner portion becomes caught on the outer periphery of the lens holding tube. Thus, the frictional resistance becomes larger, and this becomes a factor that hinders the smooth movement of the lens holding tube.

In addition, if the frictional resistance is large, the force that drives the cam follower (the force that causes the zoom ring to rotate about the axis) also becomes large, and thus, the lens holding tube itself may sometimes rotate about the axis and become inclined by receiving the force that causes the zoom ring to rotate.

Furthermore, in the lens body tube that is rigorously adjusted in the manner described above, the number of management steps and the number of working steps increases, and in addition, the frictional resistance that is generated when the lens holding tube is inserted into the stationary tube is large because the above-mentioned gap is small. Thus, the lens body tube is not easy to assemble. Consequently, this has been a cause of a decrease in the yield of the lens body tube.

In addition, there is also a method of reducing the frictional resistance by selecting a combination of the stationary tube and the lens holding tube or by processing the outer periphery of the lens holding tube (forming a slit in the outer periphery of the lens holding tube or shaving off a portion of the outer periphery of the lens holding tube such that the outer periphery is D-shaped when viewed in cross section) so as to suppress a decrease in yield. However, the number of working steps increases in both the methods, and thus, these methods are not always preferable.

It is an object of the present disclosure to provide a frame for lens capable of reducing its movement in a tube member, which is disposed in a body tube, in directions other than an optical axis direction, capable of moving smoothly in the optical axis direction, and capable of improving yield.

### SUMMARY OF THE INVENTION

A frame for lens according to the present disclosure that holds a lens and that is placed in a tube member, which is disposed in a body tube, in such a manner as to move in an axial direction of the tube member includes a tubular main body having an inner side to which the lens is fixed, at least one support portion provided on a first outer peripheral portion that is one of two equal portions of an outer peripheral portion of the main body, the two equal portions being obtained by dividing the outer peripheral portion of the main body along a first plane that includes a central axis of the main body and that extends along the central axis, and at least one elastic member provided between a second outer peripheral portion that is another one of the two equal portions, which are obtained by dividing the outer peripheral portion along the first plane, and an inner peripheral portion of the tube member. The main body is urged by the elastic member toward a side on which the first outer peripheral portion is present, and the support portion is brought into contact with the inner peripheral portion of the tube member in such a manner that the main body is held by the tube member.

In the frame for lens according to the present disclosure, a plurality of the support portions is provided, and at least two of the support portions are brought into contact with the inner peripheral portion of the tube member.

In the frame for lens according to the present disclosure, at least one of the support portions is provided in such a manner as to be displaced in a circumferential direction of the outer peripheral portion.

In the frame for lens according to the present disclosure, at least one of the support portions is provided in such a manner as to be displaced in an axial direction of the main body.

In the frame for lens according to the present disclosure, the support portions are arranged about a plane of symmetry that is a second plane including the central axis of the main body and extending perpendicularly to the first plane along the central axis.

In the frame for lens according to the present disclosure, at least one of the support portions is provided on a first center portion at which a second plane that includes the central axis of the main body and that extends perpendicularly to the first plane along the central axis and the first outer peripheral portion intersect each other.

In the frame for lens according to the present disclosure, the elastic member is provided on a second center portion at which a second plane that includes the central axis of the main body and that extends perpendicularly to the first plane along the central axis and the second outer peripheral portion intersect each other.

In the frame for lens according to the present disclosure, a plurality of the elastic members is arranged on the second center portion along an axial direction of the main body.

In the frame for lens according to the present disclosure, a plurality of the elastic members is provided, and the elastic members are arranged about a plane of symmetry that is a second plane that includes the central axis of the main body and that extends perpendicularly to the first plane along the central axis.

In the frame for lens according to the present disclosure, the support portion is formed in a convex manner, and a diameter of an imaginary circle whose circumference includes a contact portion of the support portion and an inner diameter of the tube member are the same as each other.

In the frame for lens according to the present disclosure, the contact portion of the support portion is formed in such a manner as to be curved along the inner peripheral portion of the tube member.

In the frame for lens according to the present disclosure, a fitting hole into which the elastic member is fitted is formed in the second outer peripheral portion, and the elastic member is fixed to the fitting hole.

A frame for lens according to the present disclosure that holds a lens and that is placed in a tube member, which is disposed in a body tube, in such a manner as to move in an axial direction of the tube member includes a tubular main body having an inner side to which the lens is fixed, at least one support portion provided on a first outer peripheral portion that is one of two equal portions of an outer peripheral portion of the main body, the two equal portions being obtained by dividing the outer peripheral portion of the main body along a first plane that includes a central axis of the main body and that extends along the central axis, and at least one elastic member provided between a second outer peripheral portion that is another one of the two equal portions, which are obtained by dividing the outer peripheral portion along the first plane, and an inner peripheral portion of the tube member. The main body is urged by the elastic member toward a side on which the first outer peripheral portion is present, and the support portion is brought into contact with the inner peripheral portion of the tube member in such a manner that the main body is held by the tube member. Thus, when the frame for lens moves inside the tube member, the reaction force of the elastic member causes the central axis of the main body to try to remain on the central axis of the tube member. As a result, inclination or offset of the central axis of the main body with respect to the central axis of the tube member is reduced, and movement of the frame for lens in directions other than the central axis direction of the tube member can be restricted. Therefore, the frame for lens can perform smooth movement.

In addition, in the frame for lens, only the support portion and the elastic member are brought into contact with the inner peripheral portion of the tube member, and thus, it is not necessary to reduce the difference between the outer diameter of the main body and the inner diameter of the tube member. Accordingly, it is not necessary to select a combination of the frame for lens and the tube member, and it is not necessary to process the outer periphery of the frame for lens in accordance with the inner diameter of the tube member. Therefore, the number of management steps and the number of working steps are reduced, so that the yield of the body tube can be improved.

### BRIEF DESCRIPTION OF THE DRAWINGS

FIG. 1A is a plan view illustrating a body tube in which a frame for lens according to an embodiment of the present disclosure is disposed.

FIG. 1B is a sectional view taken along line A-A of FIG. 1A.

FIG. 2A is a plan view of the frame for lens according to the embodiment of the present disclosure.

FIG. 2B is a bottom view of the frame for lens according to the embodiment of the present disclosure.

FIG. 3A is a front view of the frame for lens according to the embodiment of the present disclosure.

FIG. 3B is a front view of a tube member into which the frame for lens according to the embodiment of the present disclosure is inserted.

FIG. 3C is a front view illustrating a state where the frame for lens according to the embodiment of the present disclosure is inserted in the tube member.

FIG. 4A is a plan view of a frame for lens according to another embodiment of the present disclosure.

FIG. 4B is a bottom view of the frame for lens according to the other embodiment of the present disclosure.

FIG. 4C is a cross-sectional view taken along line A-A of FIG. 4A.

FIG. 5A is a plan view of a frame for lens according to another embodiment of the present disclosure.

FIG. 5B is a bottom view of the frame for lens according to the other embodiment of the present disclosure.

FIG. 5C is a cross-sectional view taken along line A-A of FIG. 5A.

FIG. 6A is a plan view of a frame for lens according to another embodiment of the present disclosure.

FIG. 6B is a bottom view of the frame for lens according to the other embodiment of the present disclosure.

FIG. 6C is a cross-sectional view taken along line A-A of FIG. 6A.

### DESCRIPTION OF THE PREFERRED EMBODIMENT

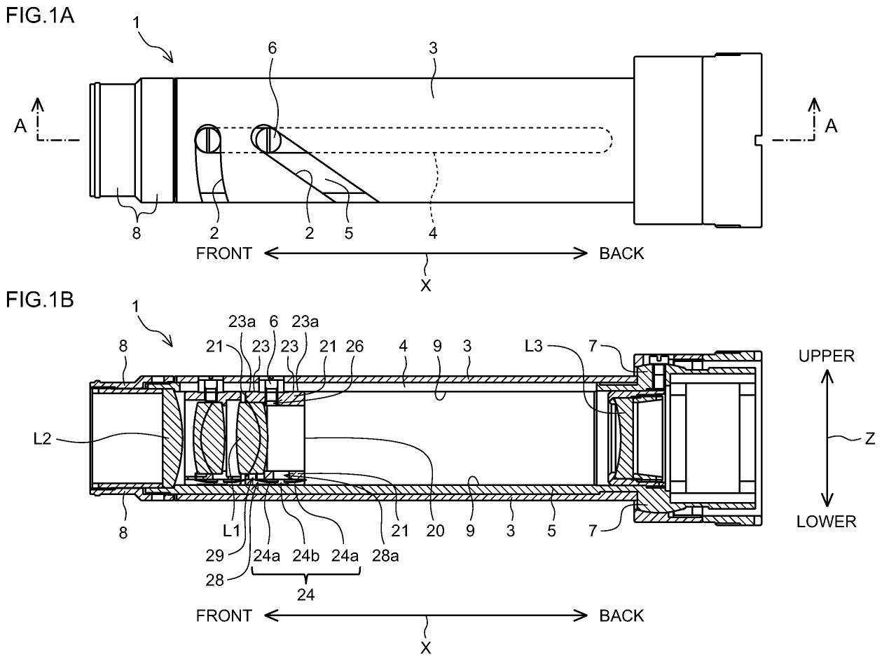

A frame for lens according to an embodiment of the present disclosure will be described with reference to FIG. 1 to FIG. 3. The frame for lens according to the present disclosure is used in a rifle scope.

As illustrated in FIG. 1A and FIG. 1B, a body tube 1 includes a rotary tube 3 that has cam grooves 2 formed in the outer periphery thereof, a stationary tube 5 that has a guide groove 4 formed in the outer periphery thereof and that is inserted into the rotary tube 3, a frame for lens 20 that is inserted into the stationary tube 5 and that moves inside the stationary tube 5 in a longitudinal direction X, and a lens L1 that is held inside the frame for lens 20. In the body tube 1, a cam follower 6 that engages with one of the cam grooves 2 and with the guide groove 4 is provided on the outer periphery of the frame for lens 20. When the rotary tube 3 is rotated about the axis of the rotary tube 3, the cam follower 6 is driven by being guided by the cam groove 2 and the guide groove 4, so that the frame for lens 20 is moved in the longitudinal direction X.

The rotary tube 3 is made of aluminum or the like and is a tubular member having a circular hole. The rotary tube 3 is disposed so as to be rotatable relative to the stationary tube 5. In addition, the rotary tube 3 has the two cam grooves 2 each extending in the circumferential direction of the rotary tube 3. The cam follower 6 engages with one of the two cam grooves 2, the one cam groove 2 being formed on the rear side. When the rotary tube 3 is rotated about its axis, the cam follower 6 is driven by being guided by the one cam groove 2.

The stationary tube 5 is made of aluminum or the like and is a tube member having a circular hole as illustrated in FIG. 1A and FIG. 1B. In the stationary tube 5, the inner wall of the circular hole serves as an inner peripheral portion 9, and a lens L2 and a lens L3 are fixed to a front end and a rear end of the inner peripheral portion 9, respectively.

The length of the stationary tube 5 in the axial direction of the stationary tube 5, that is, the longitudinal direction X, is longer than that of the rotary tube 3, and a large outer diameter portion 7 is formed at a rear end of the stationary tube 5. Thus, when the stationary tube 5 is inserted into the rotary tube 3 such that the large outer diameter portion 7 comes into contact with a rear end of the rotary tube 3, a front end of the stationary tube 5 projects from a front end of the rotary tube 3. A stop ring 8 is fixed to this projecting end portion of the stationary tube 5.

The guide groove 4 is formed in the outer periphery of the stationary tube 5 so as to extend linearly in the longitudinal direction X. Similar to one of the cam grooves 2, the guide groove 4 engages with the cam follower 6. The cam follower 6 is guided by the cam groove 2 and the guide groove 4 so as to be driven in the longitudinal direction X of the stationary tube 5. As the cam follower 6 is driven, the frame for lens 20 moves in the longitudinal direction X, that is, an optical axis direction.

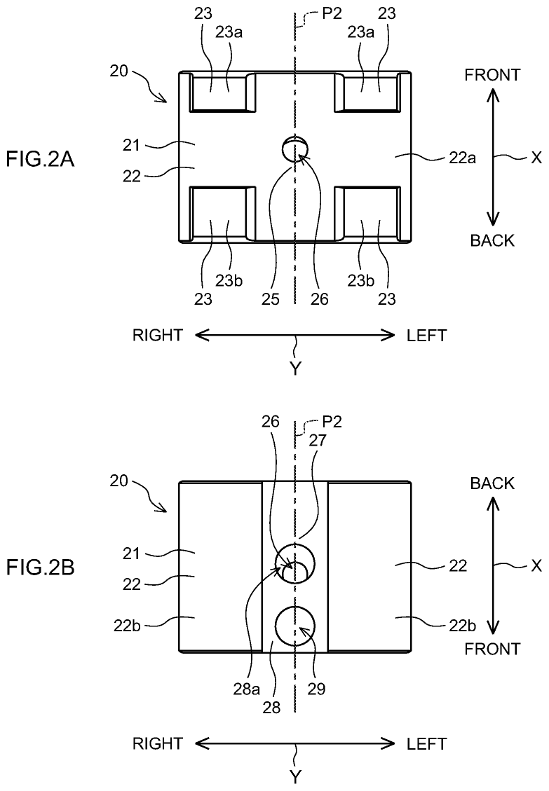

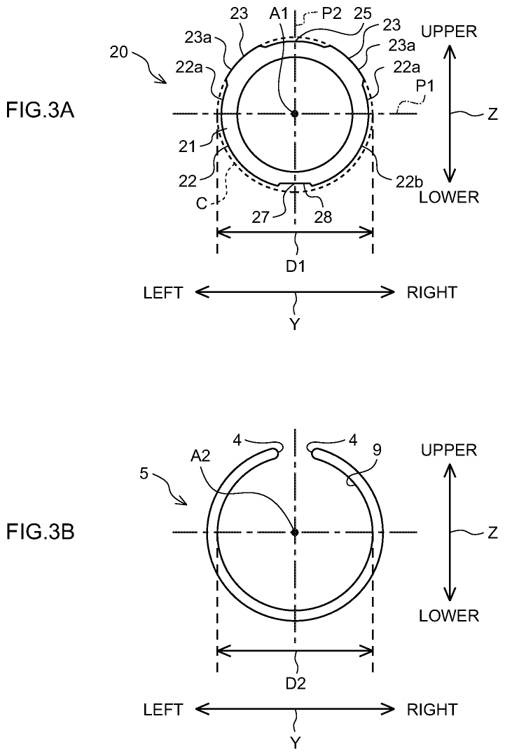

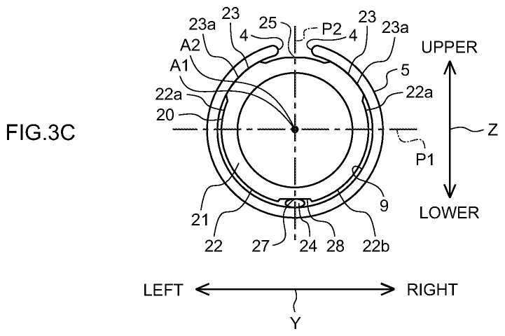

As illustrated in FIG. 2 and FIG. 3, the frame for lens 20 is a tubular member that is made of a resin and that has a circular hole and includes a main body 21 and support portions 23 that are formed on an outer peripheral portion 22 of the main body 21. An elastic member 24, which will be described later, is disposed between the outer peripheral portion 22 and the inner peripheral portion 9 of the stationary tube 5 (see FIG. 3C). The frame for lens 20 is inserted into the stationary tube 5 with the lens L1 fixed to the inner side of the frame for lens 20. In the longitudinal direction X, the length of the frame for lens 20 is shorter than that of the rotary tube 3 and shorter than that of the stationary tube 5, and the frame for lens 20 moves in the axial direction of the stationary tube 5 in the stationary tube 5.

The support portions 23 are protruding portions that protrude from the outer peripheral portion 22 of the main body 21 and are formed integrally with the main body 21. As illustrated in FIG. 2A and FIG. 3A, the support portions 23 are formed on an upper outer peripheral portion 22a (first outer peripheral portion) that is one of two equal portions of the outer peripheral portion 22 and that is located on the upper side in the vertical direction Z, the two equal portions being obtained by dividing the outer peripheral portion 22 along a horizontal plane P1 (first plane) that includes a central axis A1 of the main body 21 and that extends horizontally along the central axis A1.

The support portions 23 are formed at four positions in total and include a pair of front support portions 23a that are formed on the front side of the upper outer peripheral portion 22a and a pair of rear support portions 23b that are formed on the rear side of the upper outer peripheral portion 22a. End portions of the support portions 23 that are brought into contact with the inner peripheral portion 9 of the stationary tube 5 are curved along the inner peripheral portion 9. The front support portions 23a and the rear support portions 23b are formed so as to have the same arc length, and each of the front support portions 23a is formed so as to be shorter than each of the rear support portions 23b. When a plane that includes the central axis A1 of the main body 21 and that extends perpendicularly to the horizontal plane P1 along the central axis A1 is referred to as a vertical plane P2 (second plane), the front support portions 23a are symmetrically formed about the vertical plane P2 functioning as the plane of symmetry, and the rear support portions 23b are symmetrically formed about the vertical plane P2 functioning as the plane of symmetry (see FIG. 2A).

As illustrated in FIG. 3A, each of the support portions 23 is disposed at a position that is displaced from the vertical plane P2 by an angle of about 45 degrees in the circumferential direction of the main body 21. It is preferable that the above angle be from 20 degrees to 80 degrees. As a result, the support portions 23 arranged on the upper outer peripheral portion 22a can be brought into contact with the inner peripheral portion 9 of the stationary tube 5 uniformly and evenly.

Here, as illustrated in FIG. 3A, when a circle that is centered on the central axis A1 of the main body 21 and whose circumference includes the end portions of the support portions 23, which are brought into contact with the inner peripheral portion 9, is referred to as an imaginary circle C, the end portions of the support portions 23, which are brought into contact with the inner peripheral portion 9, are curved along the imaginary circle C. A diameter D1 of the imaginary circle C is the same as an inner diameter D2 of the stationary tube 5 (see FIG. 3B).

The outer periphery of the main body 21 includes a top portion 25 (first center portion) at which the upper outer peripheral portion 22a and the vertical plane P2 intersect each other, and a fixing hole 26 is formed in the top portion 25 (see FIG. 2A). The cam follower 6 that has a rod-like shape is placed in the fixing hole 26. The cam follower 6 is disposed so as to project from the upper outer peripheral portion 22a, and an end portion of the cam follower 6 engages with one of the cam grooves 2 and with the guide groove 4. Note that the cam follower 6 can be disposed at an arbitrary position where the support portions 23 and the elastic member 24, which will be described below, do not interfere with the cam grooves 2 or the guide groove 4.

As illustrated in FIG. 3C, the elastic member 24 is disposed between the outer peripheral portion 22 of the main body 21 and the inner peripheral portion 9 of the stationary tube 5. The main body 21 is urged by the elastic member 24 toward the side on which the upper outer peripheral portion 22a is present. A plate spring and a rubber member can be used for the elastic member 24, and in the present embodiment, the elastic member 24 that includes a plate spring member 24a and a resin member 24b is used. The plate spring member 24a is disposed on a bottom portion 27 (second center portion) included in a lower outer peripheral portion 22b (second outer peripheral portion) that is the other of the two equal portions of the outer peripheral portion 22, which are obtained by dividing the outer peripheral portion 22 along the horizontal plane P1, and that is located on the lower side in the vertical direction Z, and the lower outer peripheral portion 22b and the vertical plane P2 intersect each other at the bottom portion 27. The bottom portion 27 has a fitting portion 28 that is formed by shaving off a surface of the bottom portion 27 linearly in the longitudinal direction X, and a fitting hole 29 is formed in the fitting portion 28. An end of the plate spring member 24a is fixed to the fitting hole 29, so that the plate spring member 24a is disposed along the fitting portion 28. The resin member 24b that reduces the frictional resistance between the plate spring member 24a and the inner peripheral portion 9 is fitted to a portion of the plate spring member 24a that is brought into contact with the inner peripheral portion 9. Note that the fitting portion 28 has a through hole 28a formed at the center thereof in the longitudinal direction X in order to prevent a base end portion of the resin member 24b from interfering with the fitting portion 28.

The frame for lens 20, which is configured as described above, moves in the longitudinal direction X as the cam follower 6 is driven by being guided by one of the cam grooves 2 and by the guide groove 4 when the rotary tube 3 is rotated about its axis. In this case, the front support portions 23a and the rear support portions 23b are brought into contact with the inner peripheral portion 9 by the reaction force of the elastic member 24. Thus, the frame for lens 20 is fixed to the inner peripheral portion 9 by at least two of the support portions 23 and by the elastic member 24.

The frame for lens 20 according to the present embodiment is configured as described above. Advantageous effects of the frame for lens 20 according to the present embodiment will now be described.

The advantageous effects of the frame for lens 20 can be obtained by bringing at least two of the support portions 23 into contact with the inner peripheral portion 9 of the stationary tube 5.

In the frame for lens 20, the four support portions 23, which are formed on the upper outer peripheral portion 22a, are brought into contact with the inner peripheral portion 9 of the stationary tube 5 by the reaction force of the elastic member 24. Thus, the main body 21 is held by the stationary tube 5 without being tilted in the stationary tube 5. In addition, when the frame for lens 20 moves inside the stationary tube 5, the reaction force of the elastic member 24 causes the central axis A1 of the main body 21 to try to remain on a central axis A2 of the stationary tube 5. As a result, inclination or offset of the central axis A1 of the main body 21 with respect to the central axis A2 of the stationary tube 5 can be reduced, and movement of the frame for lens 20 in directions other than the central axis A2 direction can be restricted. Therefore, the frame for lens 20 can smoothly move inside the stationary tube 5. In particular, since the support portions 23 are made of a resin, it is unlikely that inclination or displacement of the frame for lens 20 will occur due to deformation of the support portions 23.

In addition, portions of the frame for lens 20 that are brought into contact with the inner peripheral portion 9 are limited to the support portions 23 and the elastic member 24, and the outer peripheral portion 22 does not come into contact with either corner portions of the cam grooves 2 or a corner portion of the guide groove 4. Thus, the frictional resistance that is generated when the frame for lens 20 moves is reduced, and the frame for lens 20 can move more smoothly.

Furthermore, in the frame for lens 20, only the support portions 23 and the elastic member 24 are brought into contact with the inner peripheral portion 9, and thus, it is not necessary to reduce the difference between the outer diameter of the main body 21 and the inner diameter D2 of the stationary tube 5 in order to reduce the above-mentioned inclination and displacement. Accordingly, it is not necessary to select a combination of the frame for lens 20 and the stationary tube 5, and it is not necessary to process the outer peripheral portion 22 of the frame for lens 20 in accordance with the inner diameter D2 of the stationary tube 5. Therefore, the number of management steps and the number of working steps are reduced, so that the yield of the body tube 1 can be improved. In particular, in the frame for lens 20, since the support portions 23, which are formed so as to protrude from the upper outer peripheral portion 22a, are brought into contact with the inner peripheral portion 9, unlike a frame for lens of the related art, a space can be formed between the outer peripheral portion 22 of the main body 21 and the inner peripheral portion 9, and thus, the frame for lens 20 can be easily inserted into the stationary tube 5.

In addition, in the frame for lens 20, the support portions 23 are curved, and the diameter D1 of the imaginary circle C is the same as the inner diameter D2 of the stationary tube 5. Thus, when the frame for lens 20 is disposed in the stationary tube 5, the central axis A1 of the main body 21 is likely to remain on the optical axis, which is the central axis A2 of the stationary tube 5. Therefore, particularly when the frame for lens 20 provided with a reticle is used in a rifle scope, the probability that the center of the reticle will be offset from the optical axis can be reduced.

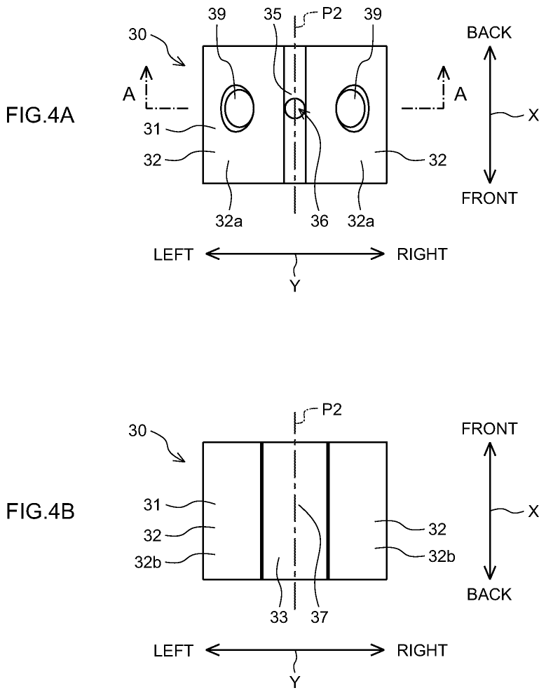

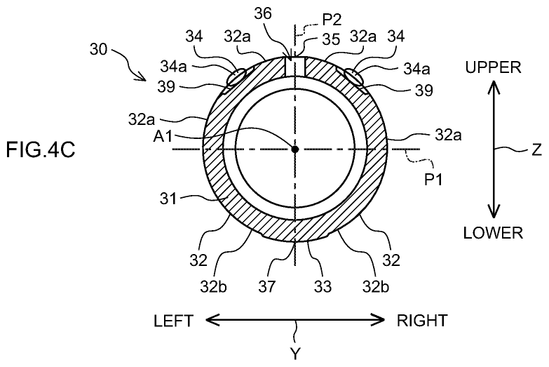

Next, a frame for lens according to another embodiment will be described with reference with FIG. 4 to FIG. 6.

For example, as illustrated in FIGS. 4A to 4C, a frame for lens 30 includes a main body 31, and an outer peripheral portion 32 of the main body 31 includes an upper outer peripheral portion 32a and a lower outer peripheral portion 32b. Fitting holes 39 each of which is a circular recess are formed in the upper outer peripheral portion 32a, and a support portion 33 is formed on a bottom portion 37 (second center portion) of the lower outer peripheral portion 32b. In the frame for lens 30, the fitting holes 39 are symmetrically arranged about the vertical plane P2 functioning as the plane of symmetry, and as illustrated in FIG. 4C, circular rubber pads 34a are fixed to the fitting holes 39 as elastic members 34.

In addition, in the frame for lens 30, the support portion 33 is formed on the bottom portion 37 (second center portion) in such a manner as to extend between the two ends of the main body 31 in the longitudinal direction X. In other words, unlike the frame for lens 20, only one support portion 33 that is long in the longitudinal direction X is provided on the bottom portion 37 (second center portion). Note that a fixing hole 36 to which the cam follower 6 is fixed is formed in a top portion 35 (first center portion), and the cam follower 6 is fixed to the fixing hole 36.

In the frame for lens 30, the rubber pads 34a are arranged so as to be symmetric to each other in the transverse direction Y, and the single support portion 33 is brought into contact with the inner peripheral portion 9 by receiving the reaction force from the two rubber pads 34a. Thus, the support portion 33 can be stably brought into contact with the inner peripheral portion 9. In addition, the support portion 33, which is formed in such a manner as to extend between the two ends of the main body 31 in the longitudinal direction X, is brought into contact with the inner peripheral portion 9, and thus, inclination of the central axis A1 of the main body 31 with respect to the central axis A2 of the stationary tube 5 can be reduced.

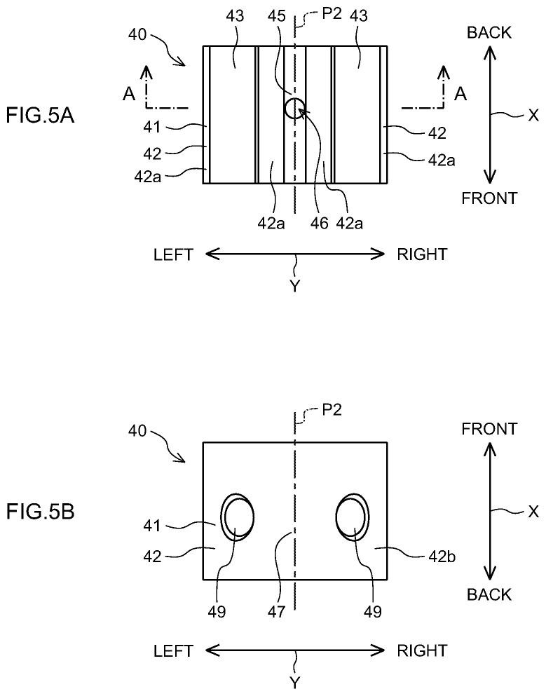

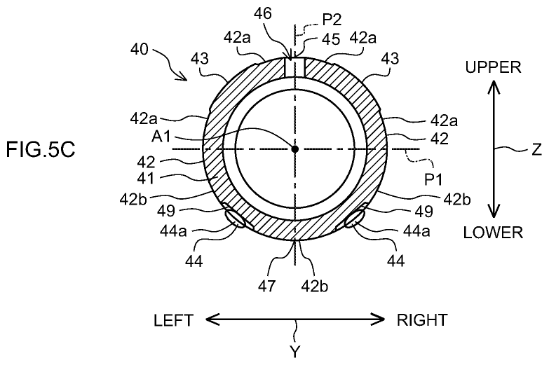

As illustrated in FIGS. 5A to 5C, a frame for lens 40 includes a main body 41, and an outer peripheral portion 42 of the main body 41 includes an upper outer peripheral portion 42a and a lower outer peripheral portion 42b. Support portions 43 are formed on the upper outer peripheral portion 42a, and fitting holes 49 each of which is a circular recess are formed in the lower outer peripheral portion 42b. In the frame for lens 40, the support portions 43 are symmetrically arranged about the vertical plane P2 functioning as the plane of symmetry, and similarly, the fitting holes 49 are symmetrically arranged about the vertical plane P2 functioning as the plane of symmetry. The support portions 43 are each formed in such a manner as to extend between the two ends of the main body 41 in the longitudinal direction X, and oval rubber pads 44a are fixed to the fitting holes 49 as elastic members 44 (see FIG. 5C). Note that a fixing hole 46 to which the cam follower 6 is fixed is formed in a top portion 45 (first center portion), and the cam follower 6 is fixed to the fixing hole 46.

In the frame for lens 40, the support portions 43, which are arranged so as to be symmetric to each other in the transverse direction Y, are brought into contact with the inner peripheral portion 9 on the upper side of the main body 41, and the elastic members 44, which are arranged so as to be symmetric to each other in the transverse direction Y, are brought into contact with the inner peripheral portion 9 on the lower side of the main body 41, so that the main body 41 is held by the stationary tube 5 such that the position of the main body 41 is more stabilized. Note that neither the support portions 43 nor the rubber pads 44a are provided on a bottom portion 47 (second center portion) of the frame for lens 40.

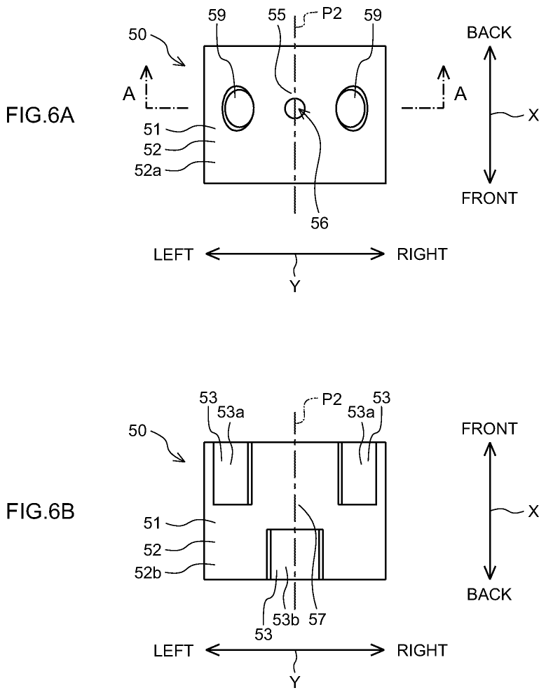

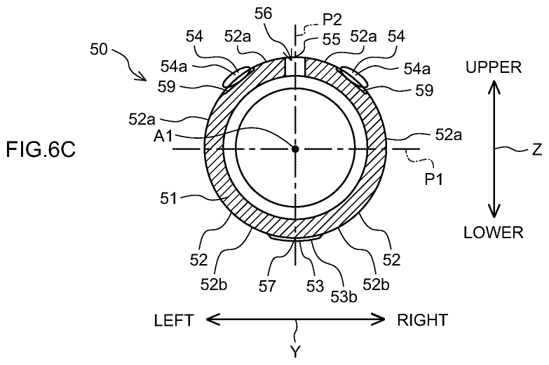

As illustrated in FIGS. 6A to 6C, a frame for lens 50 includes a main body 51, and an outer peripheral portion 52 of the main body 51 includes an upper outer peripheral portion 52a and a lower outer peripheral portion 52b. Fitting holes 59 each of which is a circular recess are formed in the upper outer peripheral portion 52a, and support portions 53 are formed on the lower outer peripheral portion 52b. In the frame for lens 50, the fitting holes 59 are symmetrically formed about the vertical plane P2 functioning as the plane of symmetry, and as illustrated in FIG. 6C, circular rubber pads 54a are fixed to the fitting holes 59 as elastic members 54.

In the frame for lens 50, the support portions 53 are formed at three positions, and two of the three support portions 53 are symmetrically formed, as front support portions 53a, about the vertical plane P2 functioning as the plane of symmetry on the front side of the lower outer peripheral portion 52b. A rear support portion 53b is formed at a position on the rear side of a bottom portion 57 (first center portion), the position being displaced from the positions of the front support portions 53a in the axial direction.

As described above, the frame for lens may have a configuration in which at least one of the plurality of support portions 53 is provided in such a manner as to be displaced in the circumferential direction of the outer peripheral portion 52 and in which at least one of the plurality of support portions 53 is provided in such a manner as to be displaced in the axial direction of the main body 51.

Note that a fixing hole 56 to which the cam follower 6 is fixed is formed in a top portion 55 (first center portion), and the cam follower 6 is fixed to the fixing hole 56.

When the frame for lens 50 is viewed from the bottom, inclination and offset of the central axis A1 of the main body 51 with respect to the central axis A2 of the stationary tube 5 can be reduced by the support portions 53 arranged at the three positions that correspond to the vertices of an inverted triangle. In addition, compared with the above-described other embodiments, each of the support portions 53 is smaller in size, and the number of support portions 53 is smaller. Thus, the frictional resistance that is generated when the frame for lens 50 moves can also be reduced.

Although the embodiments of the present disclosure have been described in detail above, the present disclosure is not limited to the above-described embodiments, and various design changes can be made within the scope of the claims.

For example, in the frame for lens of each embodiment, the positions of the support portions and the positions of the elastic members may be inverted in the vertical direction, the transverse direction, or the longitudinal direction. The support portions and the elastic members may be combined separately. In addition, a plurality of support portions or a plurality of elastic members may be arranged on the top portion (first center portion) or the bottom portion (second center portion) in the longitudinal direction. Furthermore, each support portion does not need to be curved along the inner peripheral portion.

In addition, each elastic member may be fixed to the inner peripheral portion of the stationary tube instead of being fixed to the outer peripheral portion of the main body. Furthermore, the shape of the main body in the frame for lens is not limited to a tubular shape and may be any shape as long as the main body can be disposed in the stationary tube.

What is claimed is:

1. A frame for lens that holds a lens and that is placed in a tube member, which is disposed in a body tube, in such a manner as to move in an axial direction of the tube member, the frame for lens comprising:
a tubular main body having an inner side to which the lens is fixed;
at least one support portion provided on a first outer peripheral portion that is one of two equal portions of an outer peripheral portion of the main body, the two equal portions being obtained by dividing the outer peripheral portion of the main body along a first plane that includes a central axis of the main body and that extends along the central axis; and
at least one elastic member provided between a second outer peripheral portion that is another one of the two equal portions, which are obtained by dividing the outer peripheral portion along the first plane, and an inner peripheral portion of the tube member,
wherein the main body is urged by the elastic member toward a side on which the first outer peripheral portion is present, and the support portion is brought into contact with the inner peripheral portion of the tube member in such a manner that the main body is held by the tube member.

2. A frame for lens according to claim 1,
wherein a plurality of the support portions is provided, and at least two of the support portions are brought into contact with the inner peripheral portion of the tube member.

3. A frame for lens according to claim 2,
wherein at least one of the support portions is provided in such a manner as to be displaced in a circumferential direction of the outer peripheral portion.

4. A frame for lens according to claim 2,
wherein at least one of the support portions is provided in such a manner as to be displaced in an axial direction of the main body.

5. A frame for lens according to claim 2,
wherein the support portions are arranged about a plane of symmetry that is a second plane including the central axis of the main body and extending perpendicularly to the first plane along the central axis.

6. A frame for lens according to claim 2,
wherein at least one of the support portions is provided on a first center portion at which a second plane that includes the central axis of the main body and that extends perpendicularly to the first plane along the central axis and the first outer peripheral portion intersect each other.

7. A frame for lens according to claim 1,
wherein the elastic member is provided on a second center portion at which a second plane that includes the central axis of the main body and that extends perpendicularly to the first plane along the central axis and the second outer peripheral portion intersect each other.

8. A frame for lens according to claim 7,
wherein a plurality of the elastic members is arranged on the second center portion along an axial direction of the main body.

9. A frame for lens according to claim 1,
wherein a plurality of the elastic members is provided, and
wherein the elastic members are arranged about a plane of symmetry that is a second plane that includes the central axis of the main body and that extends perpendicularly to the first plane along the central axis.

10. A frame for lens according to claim 1,
wherein the support portion is formed in a convex manner, and
wherein a diameter of an imaginary circle whose circumference includes a contact portion of the support portion and an inner diameter of the tube member are the same as each other.

11. A frame for lens according to claim 10,
wherein the contact portion of the support portion is formed in such a manner as to be curved along the inner peripheral portion of the tube member.

12. A frame for lens according to claim 1,
wherein a fitting hole into which the elastic member is fitted is formed in the second outer peripheral portion, and
wherein the elastic member is fixed to the fitting hole.
